(19) United States
(12) Patent Application Publication
(10) Pub. No.: US 2025/0323336 A1
(43) Pub. Date: Oct. 16, 2025

(54) SYSTEMS AND METHODS FOR RECYCLING ENERGY STORAGE DEVICES

(71) Applicant: AMERMIN LLC, Austin, TX (US)

(72) Inventor: Ryan McAdams, Austin, TX (US)

(21) Appl. No.: 19/071,538

(22) Filed: Mar. 5, 2025

Related U.S. Application Data
(60) Provisional application No. 63/561,679, filed on Mar. 5, 2024.
(60) Provisional application No. 63/632,908, filed on Apr. 11, 2024.

(51) Int. Cl. H01M 10/54; C22B 3/06; C22B 3/08; C22B 3/10; C22B 15/00; C22B 47/00; C25C 1/12

(52) U.S. Cl. CPC H01M 10/54; C22B 3/065; C22B 3/08; C22B 3/10; C22B 15/0089; C22B 47/00; C25C 1/12

(57) ABSTRACT

A method for recovering components of an energy storage device includes leaching a black mass recovered from the energy storage device using an acid to form an acidic aqueous solution; filtering insoluble components from the acid aqueous solution; increasing the pH of the acidic aqueous solution within a range of 7 to 9 using a base to precipitate tungsten hydroxide; filtering the tungsten hydroxide to provide a filtered aqueous solution; increasing the pH of the filtered aqueous solution to within a range of 9 to 10 to precipitate lithium hydroxide; and filtering the lithium hydroxide from the aqueous solution.

### BACKGROUND

Lithium-ion batteries have become the cornerstone of modern energy storage since their commercial introduction in the early 1990s. Conventional lithium-ion batteries provide high energy density, low self-discharge rate, and long cycle life, making such batteries useful in a wide array of applications, from small electronic devices like smartphones and laptops to larger applications, such as electric vehicles (EVs) and energy storage systems for renewable energy grids.

Lithium-ion batteries revolutionized the market for consumer electronics by offering longer life and more power than previous battery technologies and find particular use in mobile phones, laptops, tablets, and various wearable devices. Similarly, desire for sustainable transportation has significantly increased the demand for lithium-ion batteries as a key enabler of the transition from internal combustion engine vehicles to EVs, providing the necessary range and power.

In addition, as the world moves towards renewable energy sources like solar and wind, which are intermittent in nature, there's a growing need for energy storage systems. Lithium-ion batteries are pivotal in these systems, helping to stabilize the grid and store energy when production exceeds demand.

The widespread adoption of these batteries has led to a surge in production. In 2021, the global lithium-ion battery market size was estimated at around USD 41.1 billion and is expected to grow significantly. The EV market, in particular, is a major driver of this growth.

However, the availability of lithium, cobalt, nickel, and other critical materials used in these batteries is finite and concentrated in specific parts of the world, leading to supply chain vulnerabilities and geopolitical tensions. Recycling helps mitigate these risks by recovering these valuable materials.

Mining and processing of the raw materials for lithium-ion batteries have significant environmental impacts, including water pollution, ecological disruption, and greenhouse gas emissions. Recycling can substantially reduce the environmental footprint by decreasing the demand for new raw materials. Furthermore, as the number of lithium-ion batteries in use grows, so does the waste management challenge. Used batteries contain hazardous materials that can pose environmental and health risks if not properly disposed of or recycled.

Moreover, recovering valuable materials like lithium, cobalt, and nickel from used batteries can be economically advantageous and can provide a secondary stream of these critical materials, reducing dependence on energy-intensive and costly mining and refining.

In summary, the escalating use of lithium-ion batteries in various sectors underscores the urgency for robust recycling mechanisms. Recycling not only presents a solution to the environmental and resource challenges posed by the extensive use of these batteries but also offers economic advantages and aligns with global sustainability efforts.

### BRIEF DESCRIPTION OF THE DRAWINGS

The present disclosure may be better understood, and its numerous features and advantages made apparent to those skilled in the art by referencing the accompanying drawings.

FIG. 1 illustrates a block flow diagram of an example recycling process.

FIG. 2 and FIG. 3 illustrate block flow diagrams of example metal recovery processes.

The use of the same reference symbols in different drawings indicates similar or identical items.

### DETAILED DESCRIPTION

In an example, a method for recovering components of an energy storage device includes leaching a black mass recovered from the energy storing device using an acid to form an acidic aqueous solution. In an example, the acid is sulfuric acid. The method can further include filtering insoluble components from the acidic aqueous solution. The pH of the aqueous solution can be increased to within a range of 7.0 and 9.0 using a base. Increasing the pH can precipitate tungsten hydroxide. In example, the base is sodium hydroxide. The method can further include filtering the tungsten hydroxide to provide a filtered aqueous solution and increasing the pH of the filtered aqueous solution to within a range of 9.0 to 11.0. Increasing the pH can precipitate lithium hydroxide. In example, the pH can be increased utilizing a base, such as sodium hydroxide. The method can further include filtering lithium hydroxide from the aqueous solution. In a further example, the method can include electrowinning the acidic aqueous solution after filtering insoluble components and prior to increasing the pH to recover copper and optionally other metal components. The method can further include performing solvent extractions on the acidic aqueous solution to recover nickel or cobalt, for example, following electrowinning and prior to increasing the pH. In an additional example, the method includes distilling the liquid of the aqueous solution following filtering lithium hydroxide to recover additional metal compounds, such as manganese metal compounds.

Modern energy storage devices such as batteries, particularly rechargeable batteries, include solid electrolytes. Such solid electrolytes can be formed of graphite, polymers, or organic compounds, along with various metals, metal ions, or metal compounds. In an example, when recycling such energy storage devices, the ground solid electrolyte of some energy storage devices is conventionally referred to as a black mass. For example, casings of the energy storage device can be removed, and the remainder of the energy storage device ground or pulverized. The ground or pulverized components can contain graphite along with various metals, metal ions, or metal compounds.

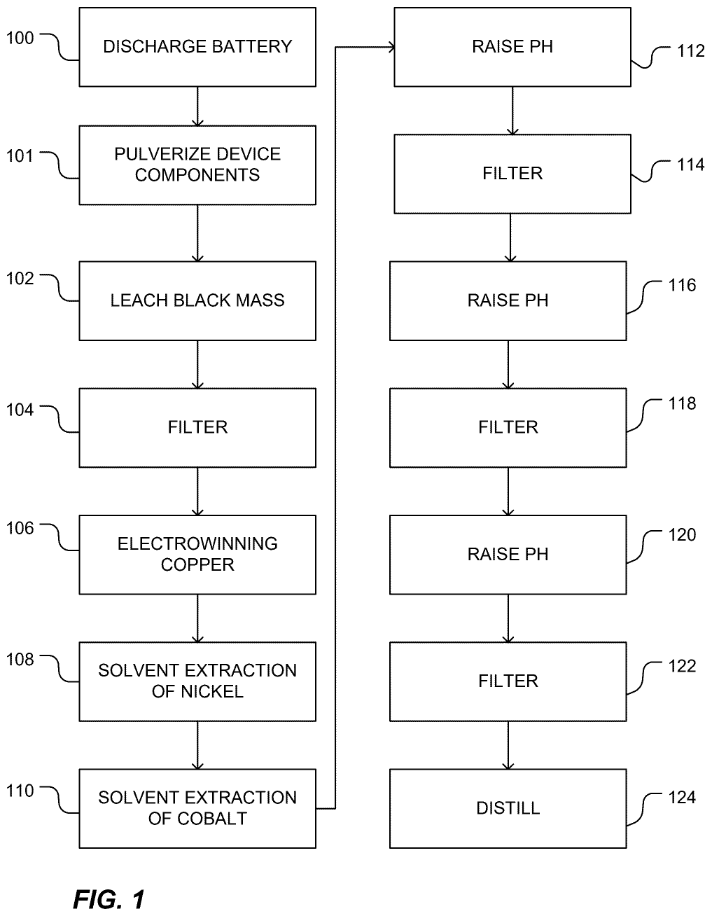

In an example method for recycling components of an energy storage device illustrated in FIG. 1, the energy storage device can be discharged, as illustrated at block 100. For example, the energy storage device can be discharged through a resistive device. Example devices include resistive heaters and optionally a cooling fan. In another example, the energy storage device can be submersed in a salt bath, shorting the energy storage device, and permitting controlled discharge.

Following discharge, the casing can be removed, and the remaining components can be ground or pulverized, as illustrated at block 101. For example, the pulverized components can include cathode, anode, and solid electrolyte materials. The resulting powdered material can be referred to as black mass.

The ground or pulverized components, such as the powdered solid electrolyte or black mass, can be leached using an acid, as illustrated at block 102. In an example, the acid can include sulfuric acid, nitric acid, hydrochloric acid, or any combination thereof. For example, the acid can include sulfuric acid, nitric acid, or combination thereof. In a particular example, the acid included sulfuric acid. The acid can have a pH in a range from 0.1 to 3.0, such as a pH in a range of 0.3 to 2.0 or a range of 0.5 to 1.5.

Leaching can provide an acidic aqueous solution and insoluble components. The acidic aqueous solution can include dissolved metals and metal ions. Insoluble components can be filtered to separate the insoluble components from the acidic aqueous solution, as illustrated at block 104. In an example, filtering can provide graphite or other carbonaceous compounds. Such graphite or carbonaceous compounds can be washed or recycled.

As illustrated at block 106, the acidic aqueous solution can undergo electrowinning to recover components such as copper. In an example, the acidic solution undergoes electrowinning using a copper cathode, such as a copper foil cathode, and an anode form from an alloy, such as a Pb—Sn—Ca alloy. Electrowinning can be performed using a power source with a voltage in a range of 6V to 20V. The electrowinning can be performed for a period in a range of 10 minutes to 10 hours, such as a range of 10 minutes to 3 hours or a range of 20 minutes to 2 hours.

Solvent extraction can be utilized to further remove metal components, such as nickel or cobalt, from the acidic aqueous solution. For example, as illustrated at block 108, solvent extraction can be utilized to separate nickel from the acidic aqueous solution. In an example, solvent extraction is performed using an extraction solvent including di-2-ethylhexyl phosphoric acid and a carrier. In an example, the carrier includes an aliphatic compound, such as an alkane, having 6 to 20 carbons or blends thereof. For example, the carrier can include an aliphatic compound having 10 to 16 carbons. For example, the carrier can include decane, undecane, dodecane, other alkanes, or combinations thereof. In a particular example, the carrier can include blends of aliphatic compounds such as naphtha or kerosene. In another example, the carrier can include plant-based oils, such as avocado oil, corn oil, canola oil, sunflower seed oil, or combinations thereof. The solvent extraction of nickel can be performed with the acidic aqueous solution having a pH in a range of 1.5 to 4.0. For example, the aqueous solution can have a pH in a range of 2.0 to 4.0.

The extraction solvent can include di-2-ethylhexyl phosphoric acid in a concentration in a range of 0.1 mol/L to 2 mol/L, such as a range of 0.1 mol/L to 1.5 mol/L or a range of 0.5 mol/L to 1.5 mol/L. Optionally, an aliphatic alcohol can be added to the extraction solvent. For example, an aliphatic alcohol having a carbon chain length of 8 to 12 carbons can be added to the extraction solvent. In an example, the aliphatic alcohol can be added at a concentration in a range of 1% to 40% by volume, such as a range of 5% to 35% by volume.

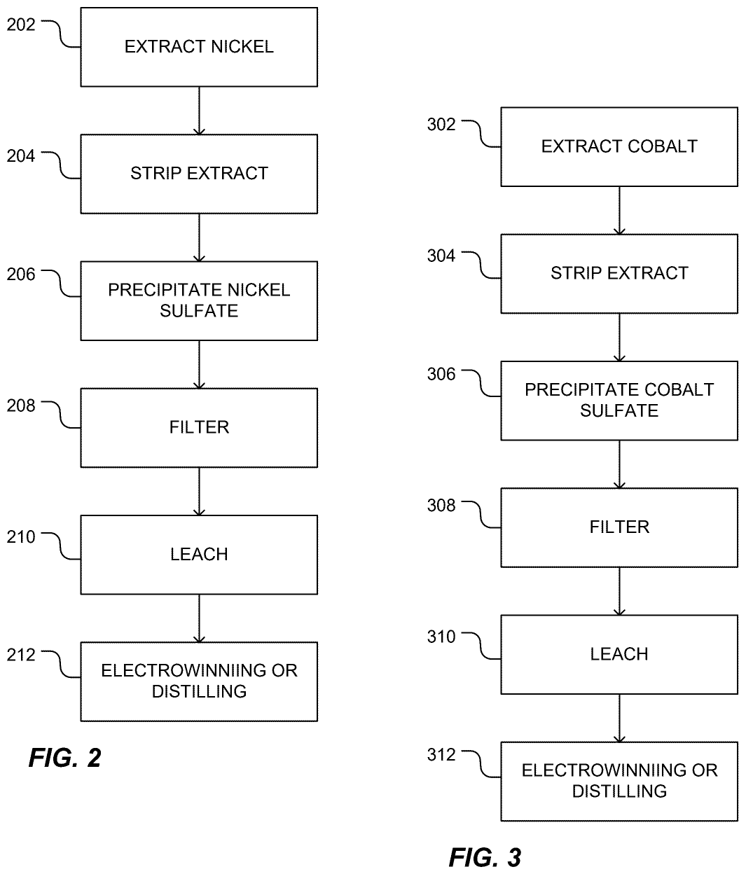

The separated nickel can be further processed. For example, the solvent extraction can be performed, as illustrated in FIG. 2 at block 202. The resulting extraction solvent can be stripped to recover nickel compounds in an aqueous solution, as illustrated at block 204. For example, the stripping solution can be an acidic solution, such as a sulfuric acid solution. The stripping solution can have a pH in a range of 0.3 to 3.0, such as a range of 0.3 to 2.0 or a range of 0.5 to 1.5. For example, the stripping solution can have 1 mM sulfuric acid, such as 10 mM sulfuric acid or 100 mM sulfuric acid. As illustrated at block 206, nickel sulfate can be precipitated from the stripping solution. The nickel sulfate can be filtered, as illustrated at block 208, and then leached, as illustrated at block 210, to further purify the recovered nickel, for example providing a recovery solution including nickel. The recovery solution can be distilled or undergo electrowinning, as illustrated at block 212. Electrowinning can include placing the recovery solution in a container with a cathode, such as a stainless-steel cathode, and an alloy anode, and applying between 6V and 24V across the electrodes for a period of 20 minutes to 10 hours.

Returning to FIG. 1, as illustrated at block 110, additional solvent extraction can be performed to isolate cobalt. The solvent extraction of cobalt can be performed with an extraction solvent including bis(2,2,4 trimethylpentyl)phosphinic acid and a carrier. An example carrier can include an aliphatic compound, such as an alkane, having 6 to 20 carbons or blends thereof. For example, the carrier can include an aliphatic compound having 10 to 16 carbons. In an example, the carrier can include decane, undecane, dodecane, other alkanes, or combinations thereof. In a particular example, the carrier can include blends of aliphatic compounds such as naphtha or kerosene. In another example, the carrier can include plant-based oils, such as avocado oil, corn oil, canola oil, sunflower seed oil, or combinations thereof.

The extraction of cobalt can be performed following the extraction of nickel. Alternatively, the extraction of cobalt can be performed prior to extraction of nickel. The extraction of cobalt can be performed with the acidic aqueous solution having a pH in a range of 2.0 to 4.8. For example, the pH can be in a range of 3.0 to 4.8, such as a range of 4.0 to 4.8.

The extraction solvent can include bis(2,2,4 trimethylpentyl)phosphinic acid in a range of 0.05 M to 2.0 M, such as a range of 0.1 M to 1.5M or a range of 0.1 M to 1.0 M.

The isolated cobalt in the extraction solvent can be further treated to recover the cobalt. For example, as illustrated in FIG. 3 at block 302, cobalt can be extracted using the extraction solvent. As illustrated at block 304, the extraction solvent can be stripped with a stripping solution to recover cobalt compounds in the stripping solution. For example, the extraction solvent can be stripped in the presence of an aqueous sulfuric acid solution. The stripping solution can have a pH in a range of 0.3 to 3.0, such as a range of 0.3 to 2.0 or a range of 0.5 to 1.5. For example, the stripping solution can have 1 mM sulfuric acid, such as 10 mM sulfuric acid or 100 mM sulfuric acid.

As illustrated at block 306, cobalt sulfate can precipitate out of the aqueous stripping solution. The precipitated cobalt sulfate can be filtered from the stripping solution, as illustrated at block 308. As illustrated at block 310, the cobalt sulfate can be leached. Such leaching can further provide a recovery solution and further purify of the cobalt. As illustrated at block 312, the cobalt can undergo electrowinning or can be distilled to recover cobalt or cobalt compounds. Electrowinning can include placing the recovery solution in a container with a cathode, such as a stainless-steel cathode, and an alloy anode, and applying between 6V and 24V across the electrodes for a period of 20 minutes to 10 hours.

Returning to FIG. 1, as illustrated at block 112, the pH of the solution can be increased using a base. An example base includes sodium hydroxide, potassium hydroxide, magnesium hydroxide, calcium hydroxide, ammonia, sodium carbonate or bicarbonate, or salts of organic acids. In an example, the base includes sodium hydroxide.

In an example, the pH of the acidic aqueous solution is increased to a pH in a range of 4.0 to 7.0 using the base. In an example, titanium hydroxide can precipitate from the aqueous solution. For example, the pH can be in a range of 5.0 to 7.0, such as a range of 5.0 to 6.8 or range of 6.0 to 6.8. Optionally, acetone can be added to the solution while the pH is being increased. The titanium hydroxide can be filtered and recovered for further processing, as illustrated at block 114.

The pH of the aqueous solution can be further increased to be within a range of 7.0 to 9.0 using a base, as illustrated at block 116. The base can be selected from the bases described above, such as sodium hydroxide. For example, the pH can be increased to within a range of 7.6 to 9.0, such as a range of 8.0 to 8.8. In an example, tungsten hydroxide can precipitate from the acidic aqueous solution. The precipitated tungsten hydroxide can be filtered, as illustrated at block 118.

In a further example, the pH of the aqueous solution can be further increased to be within a range of 9.0 to 11.0 using a base, as illustrated at block 120. The base can be selected from the bases described above, such as sodium hydroxide. For example, the pH can be increased to within a range of 9.0 to 10.5, such as a range of 9.3 to 10.5 or range of 9.3 to 10.0. As illustrated at block 122, the precipitated lithium hydroxide can be filtered from the aqueous solution.

In an example, remaining aqueous solution can be further distilled, as illustrated at block 124. In particular, distilling the aqueous solution resulted in the recovery of other metal compounds, such as manganese compounds.

### EXAMPLE

Casing materials are removed from a lithium-ion battery and the remaining components, including the electrolyte, are pulverized and ground into a powder. The powder is exposed to a 100 mM sulfuric acid solution for a period of two hours. The slurry is stirred during leaching.

The slurry is filtered to remove insoluble components and provide an acidic aqueous solution. The insoluble components are washed, providing a black graphite remnant.

The acidic aqueous solution is placed in an electrowinning cell having a copper foil cathode and an alloy anode. A 12 V power source is applied across the anode and cathode for a period of two hours, resulting in deposition of copper on the copper foil cathode.

The acidic aqueous solution is removed from the electrowinning cell. The acidic aqueous solution is placed in a jar with an extraction solvent including decane and di-2-ethylhexyl phosphoric acid at a concentration of 0.5 mol/L. The acidic aqueous solution and extraction solvent are agitated through shaking for a period of one hour. The acidic aqueous solution and solvent are allowed to separate, and the extraction solvent is decanted from the acidic aqueous solution.

The extraction solvent is placed in a container with a 100 mM sulfuric acid solution. The acid solution and extraction solvent are agitated for a period of 45 minutes. Following agitation, the solutions are allowed to separate, and the extraction solvent is decanted from the acid solution. Nickel sulfate precipitates from the acidic solution and is filtered.

The acidic aqueous solution is placed in a container with an extraction solvent including decane and bis(2,2,4 trimethylpentyl)phosphinic acid at a concentration of 0.3 M. The acidic aqueous solution and extraction solvent are agitated through shaking for a period of one hour. The acidic aqueous solution and solvent are allowed to separate, and the extraction solvent is decanted from the acidic aqueous solution.

The extraction solvent is placed in a container with a 100 mM sulfuric acid solution. The acid solution and extraction solvent are agitated for a period of 45 minutes. Following agitation, the solutions are allowed to separate, and the extraction solvent is decanted from the acid solution. Cobalt sulfate precipitates from the acidic solution and is filtered.

The pH of the acidic aqueous solution is increased with the addition of 1 M sodium hydroxide. The pH is increased to within a range of 7.0 to 9.0. As the pH increases to within the range, tungsten hydroxide precipitates. The acidic aqueous solution is stirred while the sodium hydroxide is added. The solution is allowed to rest for a period of three hours, allowing for the settling of precipitate. The tungsten hydroxide is filtered from the aqueous solution and dried.

The pH of the aqueous solution is further increased with the addition of 1 M sodium hydroxide. The pH is increased to within a range of 9.0 to 10. As the pH increases to within the range, lithium hydroxide precipitates. The acidic aqueous solution is stirred while the sodium hydroxide is added. The solution is allowed to rest for a period of three hours, allowing for the settling of precipitate. Lithium hydroxide is filtered from the aqueous solution and dried.

The remaining aqueous solution is distilled to move the water, leaving additional metallic compounds. In particular, metallic compounds are found to include manganese compounds.

In a first aspect, a method for recovering components of an energy storage device includes leaching a black mass recovered from the energy storage device using an acid to form an acidic aqueous solution. The method includes filtering insoluble components from the acid aqueous solution and increasing the pH of the acidic aqueous solution within a range of 7 to 9 using a base to precipitate tungsten hydroxide. The method further includes filtering the tungsten hydroxide to provide a filtered aqueous solution, increasing the pH of the filtered aqueous solution to within a range of 9 to 10 to precipitate lithium hydroxide, and filtering the lithium hydroxide from the aqueous solution.

In an example of the first aspect, the acid includes sulfuric acid, nitric acid, hydrochloric acid, or a combination thereof.

In another example of the first aspect and the above examples, the acid includes sulfuric acid, nitric acid, or a combination thereof. For example, the acid includes sulfuric acid.

In an additional example of the first aspect and the above examples, the base includes sodium hydroxide, potassium hydroxide, magnesium hydroxide, calcium hydroxide, sodium carbonate or bicarbonate, a salt of organic acid, or a combination thereof. For example, the base includes sodium hydroxide.

In a further example of the first aspect and the above examples, the method further comprises electrowinning the acid aqueous solution after filtering to recover copper. For example, electrowinning includes electrowinning with a copper foil cathode. In an example, electrowinning is performed with a power source of 6V to 24V.

In another example of the first aspect and the above examples, the method further comprises extracting nickel from the acidic aqueous solution with an extraction solvent including di-2-ethylhexyl phosphoric acid and a carrier. For example, the extraction solvent includes di-2-ethylhexyl phosphoric acid in a concentration in a range of 0.1 mol/L to 2.0 mol/L. In an example, extracting nickel is performed at a pH in a range of 1.5 to 4.0 in the aqueous solution. In another example of the first aspect and the above examples, the carrier includes an aliphatic compound having 6-20 carbons or blends thereof. In an additional example of the first aspect and the above examples, the extraction solvent further includes an aliphatic alcohol having 6 to 12 carbons.

In an additional example of the first aspect and the above examples, the method further comprises stripping nickel from the extraction solvent with a stripping solution, precipitating nickel from the stripping solution, and filtering the stripping solution to provide nickel sulfate. For example, the method further comprises leaching the nickel sulfate. In an example of the first aspect and the above examples, the method further comprises electrowinning nickel from the leached nickel sulfate. In another example of the first aspect and the above examples, the method further comprises distilling nickel from the leached nickel sulfate.

In a further example of the first aspect and the above examples, the method further comprises extracting cobalt from the acidic aqueous solution with an extraction solvent including bis(2,2,4 trimethylpentyl)phosphinic acid and a carrier. For example, extracting cobalt is performed following extracting nickel. In an example, the extraction solvent includes bis(2,2,4 trimethylpentyl)phosphinic acid in a concentration in a range of 0.05 M to 2.0 M. In another example of the first aspect and the above examples, extracting cobalt is performed at a pH in a range of 2.0 to 4.8 in the aqueous solution. In a further example, the carrier includes an aliphatic compound having 6-20 carbons or blends thereof. In an additional example of the first aspect and the above examples, the method further comprises stripping cobalt from the extraction solvent with a stripping solution, precipitating cobalt from the stripping solution, and filtering the stripping solution to provide cobalt sulfate. For example, the method further comprises leaching the cobalt sulfate. In an example, the method further comprises electrowinning cobalt from the leached cobalt sulfate. In another example of the first aspect and the above examples, the method further comprises distilling cobalt from the leached cobalt sulfate.

In an example of the first aspect and the above examples, the method further comprises, prior to increasing the pH of the acidic aqueous solution to precipitate tungsten hydroxide, raising the pH of the acidic aqueous solution to a range of 4.0 to 7.0 using a base to precipitate titanium hydroxide.

In an example of the first aspect and the above examples, the method further comprises adding acetone when raising the pH of the acidic solution to a range of 4.0 to 7.0.

In an example of the first aspect and the above examples, the method further comprises distilling the aqueous solutions following filtering the lithium hydroxide to recover manganese compounds.

In a second aspect of the invention, a composition includes one of lithium, tungsten, titanium, nickel, cobalt, or copper recovered through the process described herein.

Note that not all of the activities described above in the general description or the examples are required, that a portion of a specific activity may not be required, and that one or more further activities may be performed in addition to those described. Still further, the order in which activities are listed are not necessarily the order in which they are performed.

In the foregoing specification, the concepts have been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” are employed to describe elements and components described herein. This is done merely for convenience and to give a general sense of the scope of the invention. This description should be read to include one or at least one and the singular also includes the plural unless it is obvious that it is meant otherwise.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed is:

1. A method for recovering components of an energy storage device, the method comprising:
leaching a black mass recovered from the energy storage device using an acid to form an acidic aqueous solution;
filtering insoluble components from the acid aqueous solution;
increasing the pH of the acidic aqueous solution within a range of 7 to 9 using a base to precipitate tungsten hydroxide;
filtering the tungsten hydroxide to provide a filtered aqueous solution;
increasing the pH of the filtered aqueous solution to within a range of 9 to 10 to precipitate lithium hydroxide; and
filtering the lithium hydroxide from the aqueous solution.

2. The method of claim 1, wherein the acid includes sulfuric acid, nitric acid, hydrochloric acid, or a combination thereof.

3. The method of claim 2, wherein the acid includes sulfuric acid, nitric acid, or a combination thereof.

4. The method of claim 3, wherein the acid includes sulfuric acid.

5. The method of claim 1, wherein the base includes sodium hydroxide, potassium hydroxide, magnesium hydroxide, calcium hydroxide, sodium carbonate or bicarbonate, a salt of organic acid, or a combination thereof.

6. The method of claim 5, wherein the base includes sodium hydroxide.

7. The method of claim 1, further comprising electrowinning the acid aqueous solution after filtering to recover copper.

8. The method of claim 7, wherein electrowinning includes electrowinning with a copper foil cathode.

9. The method of claim 1, further comprising extracting nickel from the acidic aqueous solution with an extraction solvent including di-2-ethylhexyl phosphoric acid and a carrier.

10. The method of claim 9, wherein the extraction solvent includes di-2-ethylhexyl phosphoric acid in a concentration in a range of 0.1 mol/L to 2.0 mol/L.

11. The method of claim 9, wherein extracting nickel is performed at a pH in a range of 1.5 to 4.0 in the aqueous solution.

12. The method of claim 9, wherein the carrier includes an aliphatic compound having 6-20 carbons or blends thereof.

13. The method of claim 9, wherein the extraction solvent further includes an aliphatic alcohol having 6 to 12 carbons.

14. The method of claim 9, further comprising stripping nickel from the extraction solvent with a stripping solution, precipitating nickel from the stripping solution, and filtering the stripping solution to provide nickel sulfate.

15. The method of claim 1, further comprising extracting cobalt from the acidic aqueous solution with an extraction solvent including bis(2,2,4 trimethylpentyl)phosphinic acid and a carrier.

16. The method of claim 15, wherein the extraction solvent includes bis(2,2,4 trimethylpentyl)phosphinic acid in a concentration in a range of 0.05 M to 2.0 M.

17. The method of claim 15, wherein extracting cobalt is performed at a pH in a range of 2.0 to 4.8 in the aqueous solution.

18. The method of claim 1, further comprising, prior to increasing the pH of the acidic aqueous solution to precipitate tungsten hydroxide, raising the pH of the acidic aqueous solution to a range of 4.0 to 7.0 using a base to precipitate titanium hydroxide.

19. The method of claim 18. further comprising adding acetone when raising the pH of the acidic solution to a range of 4.0 to 7.0.

20. The method of claim 1. further comprising distilling the aqueous solutions following filtering the lithium hydroxide to recover manganese compounds.
